(19) United States
(12) Patent Application Publication
(10) Pub. No.: US 2013/0165578 A1
(43) Pub. Date: Jun. 27, 2013

(54) TIRE WITH RUBBER COMPONENT CONTAINING FUNCTIONALIZED POLYBUTADIENE AND FUNCTIONALIZED STYRENE/BUTADIENE ELASTOMERS

(71) Applicants: William Paul Francik, Bath, OH (US); Christin Louise Alwardt, Akron, OH (US); Michael Joseph Rachita, North Canton, OH (US); Stephan Rodewald, Canal Fulton, OH (US)

(72) Inventors: William Paul Francik, Bath, OH (US); Christin Louise Alwardt, Akron, OH (US); Michael Joseph Rachita, North Canton, OH (US); Stephan Rodewald, Canal Fulton, OH (US)

(21) Appl. No.: 13/664,468

(22) Filed: Oct. 31, 2012

Related U.S. Application Data
(60) Provisional application No. 61/579,138, filed on Dec. 22, 2011.

(51) Int. Cl. C08L 9/06; C08K 3/36; C08K 3/04

(52) U.S. Cl. 524/516; 525/203; 524/521

(57) ABSTRACT

Pneumatic rubber tire with a component comprised of a silica reinforced rubber composition comprised of a combination of functionalized polybutadiene rubber and functionalized styrene/butadiene elastomer.

### FIELD OF THE INVENTION

Pneumatic rubber tire with a component comprised of a silica reinforced rubber composition comprised of a combination of functionalized polybutadiene rubber and functionalized styrene/butadiene rubber.

### BACKGROUND OF THE INVENTION

It is normally desirable for pneumatic rubber tires to contain various components which have beneficial viscoelastic properties.

For example, in the case of treads for pneumatic rubber tires, it is often desired that the treads are of a rubber composition which will provide properties which promote good wear resistance, wet traction (wet skid resistance) and acceptable rolling resistance for the tire itself. Such desirable rubber composition properties for the various tire components rely, in large part, upon viscoelastic properties of the elastomers, or combination of elastomers.

For example, in order to promote lower rolling resistance and to promote tread wear resistance properties for a tire tread, elastomers having relatively high rebound property values, representing a relatively low energy loss during operation of the tire have been used to provide tire tread rubber compositions.

However, to promote wet traction (wet skid resistance) for a tire tread, elastomers having a relatively low rebound value, representing a relatively high energy loss during operation of the tire have been used for a tire tread rubber composition.

It is appreciated that it is often difficult to improve one of such viscoelastomeric properties without adversely affecting one or more of the other properties. Such difficulty and challenge is well known to those having skill in such art.

In order to balance such viscoelastically inconsistent properties, mixtures of various elastomers are normally used for tire tread rubber compositions. For example, mixtures of styrene/butadiene elastomers and polybutadiene elastomers have been used for a tire tread rubber compositions, sometimes with an addition of cis 1,4-polyisoprene rubber.

It has previously been suggested to provide a tire tread as a silica reinforcement-containing rubber composition containing a combination of functionalized styrene/butadiene rubber together with polybutadiene rubber (non-functionalized).

Such styrene/butadiene rubber was functionalized with a combination of alkoxysilane and thiol groups to promote enhancement of the silica reinforcement for the rubber composition. In this manner, then, it is envisioned that the silica (e.g. precipitated silica) becomes associated with the functionalized styrene/butadiene rubber by reaction of the precipitated silica's hydroxyl groups with the functionalized styrene/butadiene rubber instead of, or in preference to, the polybutadiene rubber and in such manner preferentially provides reinforcement, or at least greater reinforcement, for the functionalized styrene/butadiene rubber instead of the non-functionalized polybutadiene rubber.

For this invention, it is desired to evaluate promoting enhancement of silica reinforcement of the polybutadiene component of the rubber composition, and thereby enhanced, or improved, silica reinforcement for the rubber composition itself, by providing the polybutadiene in a form of functionalized polybutadiene to be used in combination with a functionalized styrene/butadiene rubber.

For this invention, it is also desired to provide the functionalized styrene/butadiene with both a moderate bound styrene content (e.g. from about 15 to about 28 or 34 percent of the styrene/butadiene rubber) to promote compatibility (miscibility) with the functionalized polybutadiene and, also, with an elevated bound styrene content (e.g. from about 35 to about 45 percent of the styrene/butadiene rubber) to promote incompatibility (immiscibility) with the functionalized polybutadiene.

In the description of this invention, the term “phr” where used means “parts of material per 100 parts by weight rubber. The terms “rubber” and “elastomer” may be use interchangeably, unless otherwise indicated. The terms “rubber composition”, “compounded rubber” and “compound” may be used interchangeably to refer to rubber, or elastomer(s), which has been blended or mixed with various ingredients and materials, unless otherwise indicated, and such terms are well known to those having skill in such art.

For this invention, the term “functionalized” relates to elastomers which contain at least one functional group which is reactive with hydroxyl groups (e.g. silanol groups) contained on precipitated silica reinforcement for the rubber composition.

### DISCLOSURE AND PRACTICE OF THE INVENTION

In accordance with this invention, a pneumatic rubber tire is provided having a component of a rubber composition comprised of, based upon parts by weight per 100 parts by weight of rubber (phr):

(A) from about 50 to about 80 phr of a solution polymerization prepared styrene/butadiene rubber (S-SBR) terminally di-functionalized at one terminal end of said styrene/butadiene rubber with a combination of both alkoxysilane and either and amine or thiol groups, particularly thiol groups, wherein said (S-SBR) has a bound styrene content of:
(1) from about 15 to about 34, alternately from about 18 to about 28, percent bound styrene units (S-SBR-A), or
(2) from about 35 to about 45 percent bound styrene units (S-SBR-B), and

(B) from about 5 to about 70 phr of in-chain functionalized polybutadiene elastomer with a having a cis 1,4-isomeric content in a range of from about 30 to about 50 percent, a trans 1,4-isomeric content in a range of from about 40 to about 60 percent which contains in-chain functionalization comprised of from about 0.2 to about 1.5 weight percent functional groups bound in the polybutadiene polymer chain;

wherein said in-chain functionalized polybutadiene elastomer is comprised of a copolymer of in-chain repeat units derived from:
(1) 1,3-butadiene monomer; and
(2) functionalized monomer in amount of from about 0.2 to about 1.5 weight percent of said 1,3-butadiene monomer having a structural formula comprised of Formula (I):

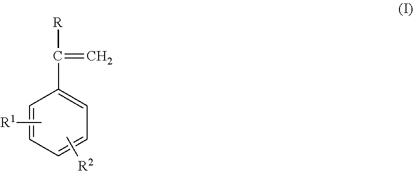

where R represents an alkyl group containing from 1 to 10 carbon atoms or a hydrogen atom and where R¹ and R² are the same or different and represent hydrogen atom, provided that both R¹ and R² cannot be hydrogen, or moiety comprised of Formula (II) or Formula (III):

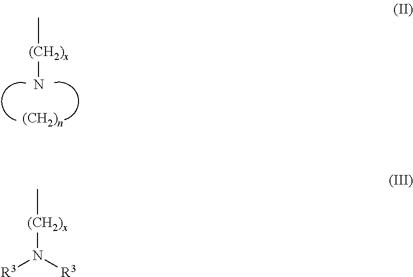

where R³ groups are the same or different and represent alkyl groups containing from 1 to 10 carbon atoms , aryl groups, allyl groups and alkyloxy groups comprised of the structural formula (IV):

—(CH₂)_{y}—O—(CH₂)_{z}—CH₂ (IV)
where n, x, y and z represent integers ranging from 1 to 10.

In one embodiment, the rubber composition contains about 40 to about 135, alternately from about 50 to about 90, phr of reinforcing filler comprised of:

(A) amorphous synthetic precipitated silica (precipitated silica), or

(B) rubber reinforcing carbon black, or

(C) combination of said precipitated silica and rubber reinforcing carbon black where said combination is desirably (optionally) comprised of said precipitated silica and rubber reinforcing carbon black of a weight ratio in a range of from about 1/1 to about 10/1.

In one embodiment, said rubber composition contains a coupling agent for said precipitated silica (e.g. when said rubber composition contains said precipitated silica) having a moiety (e.g. a siloxy moiety) reactive with hydroxyl groups (e.g. silanol groups) on said precipitated silica and another moiety interactive with one of said elastomers (e.g. with carbon-carbon double bonds contained in said elastomers).

A representative example of functionalized monomers represented by structural formula (I) is, for example, pyrrolidine ethyl styrene, (PES).

A representative example of functionalized monomers represented by structural formula (I) is, for example, vinyl benzyl pyrrolidine.

A representative example of functionalized monomers represented by structural formula (I) is, for example, vinyl benzyl dimethyl amine.

Accordingly, in one embodiment, the in-chain functionalized polybutadiene may be comprised of repeat units derived from 1,3-butadiene and at least one of pyrrolidine ethyl styrene, vinyl benzyl dimethyl amine and vinyl benzyl pyrrolidine.

In one embodiment, said polybutadiene copolymer further contains repeat units derived from isoprene where isoprene monomer is copolymerized with said 1,3-butadiene and functionalized monomer(s). Said repeat units of isoprene may, for example, constitute from about 2 to about 25, alternately from about 2 to about 15, weight percent of said polybutadiene copolymer.

For example and in one embodiment, said functionalized polybutadiene rubber is a copolymer of 1,3-butadiene and functionalized monomer prepared by anionic copolymerization of the 1,3-butadiene and functional monomers in a hydrocarbon solvent in the presence of a polymerization initiator comprised of n-butyllithium to initiate the copolymerization for which may be added a polymerization modifier to promote incorporation (distribution) of the functional monomer units along the polybutadiene chain such as, for example and not limited to, tetramethylethylenediamine (which may sometimes be referred to as TMEDA).

In one embodiment, as previously indicated, the polybutadiene (prepared by the aforesaid n-butyllithium copolymerization initiator) may be comprised of a cis 1,4-isomeric content in a range of from about 30 to about 50 percent, a trans 1,4-isomeric content in a range of from about 40 to about 60 percent and a vinyl 1,2-content in a range of from about 5 to about 20 percent with a typical glass transition temperature (Tg) in a range of from about −85° C. to about −95° C. Its number average molecular weight (Mn), may be for example, in a range of from about 75,000 to about 350,000 and its heterogeneity index of weight average to number average (Mw/Mn) may be in a range, for example, of from about 1 to about 2.5, alternately from about 1.5 to about 2.5. For example, see U.S. Pat. No. 6,664,328.

In one embodiment, at least one of said terminal di-functionalized styrene/butadiene elastomer and said in-chain functionalized polybutadiene elastomer is at least partially chain extended with tin tetrachloride or silicon tetrachloride, particularly with tin tetrachloride.

For convenience, polybutadiene rubber prepared by the n-butyllithium initiated polymerization may be referred to herein as “lithium polybutadiene” and functionalized polybutadiene rubber prepared by the n-butyllithium initiated copolymerization may be referred to herein as a “lithium polybutadiene copolymer”.

This is in contrast to, and instead of, a polybutadiene prepared by solution polymerization of 1,3-butadiene in the presence of a nickel based polymerization catalyst to form a polybutadiene elastomer from 1,3 butadiene monomer (which might sometimes be referred to as a nickel polybutadiene elastomer) having a microstructure comprised of at least 90 percent cis 1,4-isomeric content and having a typical Tg in a range of from about −100° C. to about −110° C. Such nickel polybutadiene elastomer may have, for example, a number average (Mn) in a range of from about 230,000 to about 250,000 with a heterogeneity index (Mw/Mn) in a range of from about 1.5 to about 2. For example, see U.S. Pat. No. 7,081,505.

The functional styrene/butadiene rubber is di-functionalized with a combination of alkoxysilane and primary amino or thiol groups, particularly thiol groups, together at the same terminal end of the styrene/butadiene elastomer as being derived from a singular di-functional polymerization terminating compound containing said combination of alkylsilane and primary amino or thiol groups.

The di-functional combination of alkoxysilyl group together with the primary amino group or thiol group, may thereby be bonded, for example, to one terminal end of the styrene/butadiene rubber to form the terminally di-functionalized styrene/butadiene rubber.

The terminally di-functionalized styrene/butadiene rubber may be produced, for example, by polymerizing styrene and butadiene in a hydrocarbon solvent by anionic polymerization using an organic alkali metal and/or an organic alkali earth metal as an initiator, adding a terminating agent compound having an alkoxysilyl group and a primary amino group protected with a protective group or a thiol group protected with a protecting group to act as a polymerization terminating agent with a living polymer chain terminal at the time when the polymerization has substantially completed, and then conducting deblocking, for example, by hydrolysis or other appropriate procedure. In one embodiment, the terminally di-functionalized styrene/butadiene rubber may be produced, for example, in a matter shown in U.S. Pat. No. 7,342,070. In another embodiment, the terminally di-functionalized styrene-butadiene rubber may be produced, for example, in a manner shown in WO 2007/047943.

In one embodiment, as mentioned in U.S. Pat. No. 7,342,070, the terminally di-functionalized styrene/butadiene rubber may be comprised of the Formula (V):

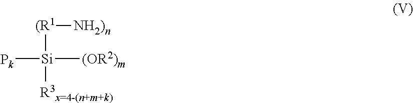

wherein P is a (co)polymer chain of styrene/butadiene copolymer, R¹ is an alkylene group having 1 to 12 carbon atoms, R² and R³ are each independently selected from an alkyl group having 1 to 20 carbon atoms, an allyl group or an aryl group, where R² is preferably an ethyl group, n is a value of 1 or 2, m is a value of from 1 or 2, preferably 2, k is a value of from 1 or 2, x is a value of 0 to 1, with the proviso that n+m+k is an integer of 3 or 4.

The terminating agent compound having a protected primary amino group and an alkoxysilyl group may be any of various compounds containing such groups as are known in the art. In one embodiment, the compound having a protected primary amino group and an alkoxysilyl group may include, for example, N,N-bis(trimethylsilyl)aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)-aminoethyltriethoxysilne, N,N-bis(trimethylsilyl)aminoethylmethyldimethoxysilane, N,N-bis(trimethylsilyl)aminoethylmethyldiethoxysilane, etc., and preferred are 1-trimethylsilyl-2,2-dimethoxy-1-aza-2-silacyclopentane, N,N-bis(trimethylsilyl)aminopropylmethyldimethoxysilane and N,N-bis(trimethylsilyl)aminopropylmethyldiethoxysilane. In one embodiment, the compound having a protected primary amino group and an alkoxysilyl group is N,N-bis(trimethylsilyl)aminopropyltriethoxysilane.

For example, styrene-butadiene rubbers terminally di-functionalized with an alkoxysilane group and a primary amine group may be, for example, HPR 355 from Japan Synthetic Rubber (JSR).

Further, and in another embodiment, the solution polymerization prepared styrene-butadiene rubber may be terminally di-functionalized with an alkoxysilane group and a thiol which may comprise, for example, a reaction product of a living anionic styrene/butadiene polymer and a silane-sulfide represented by the formula VI:

(R⁴O)ₓR⁴_{y}Si—R⁵—S—SiR⁴₃ (VI)

wherein Si is silicon; S is sulfur; O is oxygen; x is an integer selected from 1, 2 and 3; y is an integer selected from 0, 1, and 2; x+y=3; R⁴ is the same or different and is (C₁-C₁₆) alkyl; and R′ is aryl, and alkyl aryl, or (C₁-C₁₆)alkyl. In one embodiment, R⁵ is a (C₁-C₁₆)alkyl. In one embodiment, each R⁴ group is the same or different, and each is independently a C₁-C₅ alkyl, and R⁵ is C₁-C₅ alkyl.

As indicated, in one embodiment the terminal di-functionalized styrene/butadiene rubber is di-functionalized at one terminal end of the styrene/butadiene elastomer with a combination of alkoxysilane and primary amine or thiol groups with a polymerization terminating di-functional compound containing a combination of alkoxysilane and primary amine or thiol groups.

For such embodiment, for example the styrene-butadiene rubber may be terminal di-functionalized with alkoxysilane and thiol groups from, for example, Styron as an alkoxysilane/thiol functionalized SBR as described in WO2007/047943.

For this evaluation, a purpose of inclusion of the in-chain functionalized polybutadiene rubber, instead of non-functionalized polybutadiene rubber, with the terminally di-functionalized styrene/butadiene rubber is to promote reaction of precipitated silica with both the functionality of the in-chain functionalized polybutadiene and the terminal di-functionalized styrene/butadiene elastomers, instead of only with the terminally di-functionalized styrene/butadiene elastomer, to create a better dispersion of the precipitated silica within and throughout the in-chain functionalized polybutadiene elastomer and thereby in the rubber composition itself. A further purpose is to promote greater abrasion resistance of the rubber composition by promoting a better and more complete dispersion of the precipitated silica particles throughout the in-chain functionalized polybutadiene and terminal di-functionalized styrene/butadiene elastomers of the rubber composition which is predictive of better abrasion resistance for the rubber composition and thereby better resistance to treadwear for a tire with such rubber composition.

In addition, an envisioned significant aspect is to create and evaluate miscible (compatible) and immiscible (incompatible) blends of the functionalized elastomers evaluating use of the terminal di-functionalized styrene/butadiene rubber with high a low bound styrene contents.

For such purpose, it is envisioned that the relatively immiscible rubber composition containing the combination of the terminally di-functionalized styrene/butadiene rubber with the high bound styrene content together with the in-chain functionalized polybutadiene rubber may also beneficially promote higher rebound physical property values for the rubber composition which is predictive of less internal heat generation, and therefore less temperature build-up for the rubber composition when it is being worked and predictive of better (lower) rolling resistance for a tire with a tread of such rubber composition. For such purpose, it is also envisioned that immiscible blends of the elastomers might be created by using the terminally di-functionalized styrene/butadiene with a high bound styrene content, to enhance abrasion resistance for the rubber composition and thereby better resistance to treadwear for a tire having a tread of such rubber composition.

Also, for this evaluation, a purpose of providing the functionalized styrene/butadiene rubber (functionalized SBR) with a significantly lower bound styrene content in a range of, for example, from about 15 to about 30 or 34 percent of the rubber is to promote its miscibility (compatibility) with the functionalized polybutadiene

The terminal di-functionalized styrene/butadiene rubber (functionalized SBR) with the low bound styrene content, used in combination with the in-chain functionalized polybutadiene may beneficially promote a reduction in rolling resistance as well as tread wear resistance for a tire with tread of such combination of functionalized elastomers although to an expected lesser degree, or extent, than the aforesaid immiscible blend of terminal di-functional functionalized styrene/butadiene and in-chain functionalized polybutadiene elastomers.

In practice, it is appreciated and preferred that the elastomers utilized in the rubber composition are exclusive of polymers and copolymers of isobutylene, including halogen modifications thereof.

Examples of reinforcing carbon blacks for elastomers, generally, together with their Iodine number values and DBP (dibutyl phthalate) absorption values, may be found in The Vanderbilt Rubber Handbook, (1990), 13th edition, Pages 416 through 419.

In the practice of this invention, use of the combinations of the aforesaid silica and rubber reinforcing carbon black reinforcing fillers in the rubber composition is provided to promote better rolling resistance (less rolling resistance) and treadwear resistance for a tire with a tread of such rubber composition which contains such combination of silica and rubber reinforcing carbon black together with the aforesaid combination of functionalized styrene/butadiene and functionalized polybutadiene elastomers.

The precipitated silicas are such as, for example, those obtained by the acidification of a soluble silicate (e.g., sodium silicate or a co-precipitation of a silicate and an aluminate).

The BET surface area of the silica, as measured using nitrogen gas, may, for example, be in a range of about 50 to about 300, alternatively about 120 to about 200, square meters per gram.

The silica may also have a dibutylphthalate (DBP) absorption value in a range of, for example, about 100 to about 400, and usually about 150 to about 300 cc/g.

Various commercially available silicas may be considered for use in this invention such as, for example only and without limitation, silicas commercially available from PPG Industries under the Hi-Sil trademark with designations 210, 243, etc; silicas available from Rhodia, with designations of Zeosil 1165MP and Zeosil 165GR and silicas available from Degussa AG with designations VN2 and VN3, 3770GR, and from Huber as Zeopol 8745.

When silica reinforcement is used for a rubber tire tread, the silica is conventionally used with a coupling agent to aid in coupling the precipitated silica to the diene-based elastomers.

Compounds capable of reacting with both the silica surface (e.g. hydroxyl groups on the silica) and the rubber elastomer (e.g. carbon-carbon double bonds in the elastomer) in a manner to cause the silica to have a reinforcing effect on the rubber, many of which are generally known to those skilled in such art as coupling agents, or couplers, are often used. Such coupling agents, for example, may be premixed, or pre-reacted, with the silica particles or added to the rubber mixture during the rubber/silica processing, or mixing, stage. If the coupling agent and silica are added separately to the rubber mix during the rubber/silica mixing, or processing stage, it is considered that the coupling agent then combines in situ with the silica.

In particular, such coupling agents may, for example, be composed of a silane which has a constituent component, or moiety, (the silane portion) capable of reacting with the silica surface and, also, a constituent component, or moiety, capable of reacting with the rubber, particularly a sulfur vulcanizable rubber which contains carbon-to-carbon double bonds, or unsaturation. In this manner, then the coupler acts as a connecting bridge between the silica and the rubber and thereby enhances the rubber reinforcement aspect of the silica.

In one aspect, the silane of the coupling agent apparently forms a bond to the silica surface, possibly through hydrolysis, and the rubber reactive component of the coupling agent combines with carbon-carbon double bonds contained in the rubber itself.

Numerous coupling agents are taught for use in combining silica and rubber such as, for example, silane coupling agents containing a polysulfide component, or structure, such as bis-(3-alkoxysilylalkl)polysulfide which contains an average from 2 to about 4 (such as for example a range of from 2 to about 2.4 or a range of from 3 to about 4) connecting sulfur atoms in its polysulfidic bridge such as, for example, a bis-(3-triethoxysilylpropyl)polysulfide.

It is readily understood by those having skill in the art that the rubber compositions of the tread would be compounded with conventional compounding ingredients including the aforesaid reinforcing fillers such as carbon black and precipitated silica, as hereinbefore defined, in combination with a silica coupling agent, as well as antidegradant(s), processing oil as hereinbefore defined, stearic acid or a zinc stearate, zinc oxide, sulfur-contributing material(s) and vulcanization accelerator(s) as hereinbefore defined.

Such compounding of rubber is well known to those having skill in such art. Antidegradants are typically of the amine or phenolic type. While stearic acid is typically referred to as a rubber compounding ingredient, it may be pointed out that the ingredient itself is usually obtained and used as a mixture of organic acids primarily composed of stearic acid with at least one of oleic acid, linolenic acid and/or palmitic acid normally contained in the stearic acid as typically used. The mixture may contain minor amounts (less than about six weight percent) of myristic acid, arachidic acid and/or arachidonic acid. Such material or mixture is conventionally referred to in the rubber compounding art as stearic acid.

Where normal or typical rubber compounding amounts or ranges of amounts of such additives are used, they are not otherwise considered as a part of the invention. For example, some of the ingredients might be classified, in one aspect, as processing aids. Such processing aids may be, for example, waxes such as microcrystalline and paraffinic waxes typically used in a range of about 1 to 5 phr and often in a range of about 1 to about 3 phr; and resins, usually as tackifiers, such as, for example, synthetic hydrocarbon and natural resins typically used in a range of about 1 to 5 phr and often in a range of about 1 to about 3 phr. A curative might be classified as a combination of sulfur and sulfur cure accelerator(s) for the rubber compound (usually simply referred to as accelerator) or a sulfur donor/accelerator. In a sulfur and accelerator(s) curative, the amount of free sulfur added to the rubber composition, in addition to the sulfur generating bis(3-triethoxysilylpropyl) polysulfide coupling agent, is in a range of about 1 to about 5 phr and more generally in a range of about 2 to about 4 phr in order to promote cross-link density of the cured rubber composition; and the accelerator(s), often of the sulfenamide type, may be used, for example, in a range of about 0.5 to about 5 phr and perhaps in a range of about 1 to about 2 phr. The ingredients, including the elastomers but exclusive of sulfur and accelerator curatives, are normally first mixed together in at least one and often in a series of at least two sequential, mixing stage(s), although sometimes one mixing stage might be used, to a temperature in a range of about 130° C. to about 140° C., and such mixing stages are typically referred to as non-productive mixing stages. Thereafter, the sulfur and accelerators, and possibly one or more retarders and one or more antidegradants, are mixed therewith to a temperature of about 90° C. to about 120° C. and is typically referred as a productive mix stage. Such mixing procedure is well known to those having skill in such art.

After mixing, the compounded rubber can be fabricated such as, for example, by extrusion through a suitable die to form a tire component such as, for example, a tire tread strip. The tire tread rubber strip is then typically built onto a sulfur curable tire carcass and the assembly thereof shaped and cured in a suitable mold under conditions of elevated temperature and pressure by methods well-known to those having skill in such art. The invention may be better understood by reference to the following example in which the parts and percentages are by weight unless otherwise indicated.

### EXAMPLE I

Miscible and immiscible blends of elastomers were prepared comprised of terminal di-functional styrene/butadiene elastomers containing about 23 percent and about 40 percent bound styrene, respectively, with polybutadiene and with in-chain functionalized polybutadiene to evaluate resultant rebound and abrasion resistance physical properties.

Two miscible blends of the elastomers were prepared as Control rubber Sample A and Experimental rubber Sample B. For such blends, the terminal di-functional styrene/butadiene elastomer contained about 23 percent bound styrene. Two immiscible blends of the elastomers were also prepared as Control rubber Sample C and Experimental rubber Sample D. For such blends, the terminal di-functional styrene/butadiene elastomer contained about 40 percent bound styrene.

Various physical properties of the rubber compositions were determined including rebound properties at 23° C. and 100° C. and tan delta properties at −10° C. as well as Grosch abrasion rates.

The basic formulation for the rubber compositions are illustrated in Table 1 in terms of parts by weight per 100 parts rubber (phr) unless otherwise indicated.

The rubber compositions for rubber Samples A and B can be prepared, for example, by mixing the elastomers(s) without sulfur and sulfur cure accelerators in a first non-productive mixing stage (NP-1) in an internal rubber mixer for about 4 minutes to a temperature of about 170° C. The rubber mixture can then be mixed in a second non-productive mixing stage (NP-2) in an internal rubber mixer for about 4 minutes to a temperature of about 160° C. with further addition of ingredients. The rubber mixture can then be mixed in a third non-productive mixing stage (NP-3) in an internal rubber mixer for about 4 minutes to a temperature of about 150° C. without further addition of ingredients. The resulting rubber mixture can then be mixed in a productive mixing stage (PR) in an internal rubber mixer with sulfur and sulfur cure accelerator(s) being added for about 2 minutes to a temperature of about 110° C. The rubber composition can be dumped from each mixer and sheeted out and cooled to below 50° C. between each of the non-productive mixing steps and prior to the productive mixing step. For rubber Samples C and D a similar mixing procedure can be used where only one non-productive mixing stage is utilized.

TABLE 1

| | Rubber Samples | | | |
|---|---|---|---|---|
| Material | Control A | B | Control C | D |
| Non-productive mixing (NP-1) | | | | |
| Functionalized SBR rubber A¹ | 70 | 70 | 0 | 0 |
| Functionalized SBR rubber B² | 0 | 0 | 70 | 70 |
| Polybutadiene rubber | 0 | 0 | 30 | 0 |
| (lithium polybutadiene)³ | | | | |
| Functionalized polybutadiene | 0 | 0 | 0 | 30 |
| rubber (lithium polybutadiene | | | | |
| copolymer)⁴ | | | | |
| Microcrystalline wax | 1.5 | 1.5 | 1.5 | 1.5 |
| Fatty acid⁵ | 2 | 2 | 2 | 2 |
| Rubber processing oil | 11 | 11 | 20 | 20 |
| Zinc oxide | 3.5 | 3.5 | 3.5 | 3.5 |
| Precipitated silcia⁶ | 33 | 33 | 65 | 65 |
| Coupling agent⁷ | 0 | 0 | 10 | 10 |
| Antidegradant | 0 | 0 | 2 | 2 |
| Non-productive mixing (NP-2) | | | | |
| Polybutadiene rubber | 30 | 0 | 0 | 0 |
| (lithium polybutadiene)³ | | | | |
| Functionalized polybutadiene | 0 | 30 | 0 | 0 |
| rubber (lithium polybutadiene | | | | |
| copolymer)⁴ | | | | |
| Antidegradant | 2 | 2 | 0 | 0 |
| Rubber processing oil | 9 | 9 | 0 | 0 |
| Precipitated silica⁶ | 32 | 32 | 0 | 0 |
| Coupling agent⁷ | 10 | 10 | 0 | 0 |
| Non-productive mixing (NP-3) | | | | |
| No ingredients added | | | | |
| Productive mixing (PR) | | | | |
| Sulfur | 1.7 | 1.2 | 1.7 | 1.2 |
| Sulfur cure accelerators (A)⁸ | 3 | 0 | 3 | 0 |
| Sulfur cure accelerators (B)⁹ | 0 | 2 | 0 | 2 |
| Antidegradant | 0.8 | 0.8 | 0.8 | 0.8 |

¹Functionalized SBR as a solution polymerization prepared styrene/butadiene rubber having a bound styrene content of about 23 percent functionalized with alkoxysilane and thiol groups and having a Tg in a range of from about −30° to about −10° C. as SLR SE4602 ™ from Styron
²Functionalized SBR as a solution polymerization prepared styrene/butadiene rubber having a bound styrene content of about 40 percent functionalized alkoxysilane and thiol groups and having a Tg in a range of from about −30° to about −40° C. as P6204M ™ from Styron
³Lithium polybutadiene as a polybutadiene prepared by polymerizing 1,3-butadiene with n-butyllithium initiated polymerization having a microstructure comprised of about 30 to about 50 percent cis 1,4-isomeric units, about 40 to about 60 percent trans 1,4-isomeric units and having from about a 5 to about 20 percent vinyl 1,2-content; a number average molecular weight (Mn) in a range of from about 75,000 to about 350,000 with a heterogeneity index (Mw/Mn) in a range of from about 1 to about 2.5 and having a Tg in a range of from about −85 to about −95° C.
⁴Lithium polybutadiene copolymer as an in-chain functionalized polybutadiene prepared by n-butyllithium initiated copolymerization of 1,3-butadiene and pyrrolidine ethyl styrene (PES) in the presence of TMEDA with the copolymer containing about 0.5 percent repeat units derived from the pyrrolidine ethyl styrene
⁵Fatty acid compromised primarily of a combination of stearic acid, oleic and palmitic acids
⁶As Zeosil 1165 MP ™ from Rhodia
⁷A 50/50 (by weight) composite of carbon black and bis-(3-triethoxysilylpropyl) polysulfide having an average in a range of from about 2 to about 3 connecting sulfur atoms in its polysulfidic bridge from Evonic as Si266 ™ and reported in the Table as the composite.
⁸Sulfur cure accelerators as a combination of N-N-dicyclohexy1-2-benzothiazolesulfenamide primary accelerator and (amine-containing) diphenylguanidine secondary accelerator in about a 75/50 ratio.
⁹Sulfur cure accelerators as a combination of N-N-dicyclohexy1-2-benzothiazolesulfenamide primary accelerator and zinc dibenzyldithiocarbamate secondary accelerator in about a 50/50 ratio. Such sulfur cure ingredients are therefore comprised of sulfur, primary sulfur cure accelerator comprised of N-N-dicyclohexy1-2-benzothiazolesulfenamide and secondary sulfur cure accelerator comprised of zinc dibenzyldithiocarbamate exclusive of diphenylguanidine. Therefore, in one embodiment, said rubber composition contains sulfur cure ingredients comprised of sulfur and sulfur cure accelerator(s) exclusive of diphenylguanidine.

The prepared rubber compositions were cured at a temperature of about 160° C. for about 14 minutes, where appropriate, and the resulting cured rubber samples evaluated with various physical properties (rounded numbers are reported herein) reported in Table 2.

TABLE 2

| | Control | Exp'l | Control | Exp'l |
|---|---|---|---|---|
| Material | A | B | C | D |
| Functionalized SBR rubber | 70 | 70 | 0 | 0 |
| A (23% styrene) | | | | |
| Functionalized SBR rubber | 0 | 0 | 70 | 70 |
| B (40% styrene) | | | | |
| Polybutadiene rubber (lithium | 30 | 0 | 30 | 0 |
| polybutadiene) | | | | |
| Functionalized polybutadiene rubber | 0 | 30 | 0 | 30 |
| (lithium polybutadiene copolymer) | | | | |
| Sulfur cure accelerators (A) | Yes | No | Yes | No |
| Sulfur cure accelerators (B) | No | Yes | No | Yes |
| Properties | | | | |
| Miscibility of Elastomers^{A} | Yes | Yes | No | No |
| RPA¹ | | | | |
| Uncured G′, 0.83 Hz, 100° C., | 0.29 | 0.39 | 0.28 | 0.36 |
| 15% strain (MPa) | | | | |
| Cured G′, 11 Hz, 40° C., | 5.4 | 4.6 | 5.6 | 3.0 |
| 1% strain (MPa) | | | | |
| Tan delta, 11 Hz, 40° C., 1% strain | 0.1 | 0.08 | 0.12 | 0.1 |
| ATS², stress-strain | | | | |
| Tensile strength (MPa) | 15.6 | 18.1 | 18.6 | 22 |
| Elongation at break (%) | 516 | 506 | 534 | 548 |
| 300% modulus, ring, (MPa) | 7.9 | 9.5 | 10.2 | 10.5 |
| Tan delta at −10° C. | 0.27 | 0.22 | 0.37 | 0.38 |
| Rebound value (Zwick) | | | | |
| 0° C. | 18.6 | 23.8 | 14.1 | 18.9 |
| 23° C. | 40.2 | 51.1 | 36.2 | 47.2 |
| 100° C. | 57.2 | 61.7 | 58.3 | 63 |
| Abrasion rate (mg/km), | | | | |
| Grosch (lower is better)³ | | | | |
| Medium (40 N), 6° slip angle, speed = | 154 | 145 | 123 | 109 |
| 20 km/hr, distance = 1,000 meters | | | | |

^{A}Miscibility (compatibility) of the elastomers is represented by a graph of tan delta versus temperature (temperature sweep of tan delta values) for the blend of the elastomers over a temperature range of about −110° C. to about +60° C. where the presence of a single significant peak in this temperature range is indicative of a miscible rubber blend and the presence of dual significant peaks (the dual peaks individually showing the presence of each of the two elastomers) is indicative of an immiscible rubber blend. Such indication of
miscibility or immiscibility of rubber blends is recognized by those having skill in such art and is reported in Table 2 as being Yes for Miscibility of the elastomers and as No for Immiscibility of the elastomers.
¹Rubber process analyzer instrument (e.g. Rubber Process Analyzer RPA 2000)
²Automated Testing System instrument by Instron for determining ultimate tensile strength, ultimate elongation, modulii, etc, of rubber samples
³The Grosch abrasion rate run on a LAT-100 Abrader and is measured in terms of mg/km of rubber abraded away. The test rubber sample is placed at a slip angle under constant load (Newtons) as it traverses a given distance on a rotating abrasive disk (disk from HB Schleifmittel GmbH). Frictional forces, both lateral and circumferential, generated by the abrading sample can be measured together with the load (Newtons) using a custom tri-axial load cell. The surface temperature of the abrading wheel is monitored during testing and
reported as an average temperature. In practice, a Low abrasion severity test may be run, for example, at a load of 20 Newtons at a slip angle of 2 degrees and a disk speed of 20 or 40 kph (kilometers per hour) at a sample travel of 7,500 m. A Medium abrasion severity test may be run, for example, at a load of 40 Newtons at a slip angle of 6 degrees and a disk speed of 20 kph and a sample travel of 1,000 m. A High abrasion severity test may be run, for example, at a load of 70 Newtons at a slip angle of 12 degrees and a disk speed of 20 kph and a sample travel of 250 m.

(A) For Miscible Elastomer Blends as Control Rubber Sample A and Experimental Rubber Sample B reported in Table 2

Rubber Samples A and B both contained the terminal di-functional styrene/butadiene elastomer with 23 percent bound styrene.

Control rubber Sample A contained non functionalized lithium polybutadiene elastomer.

Experimental rubber Sample B contained in-chain functionalized lithium polybutadiene copolymer.

From Table 2 it is seen that the rebound value (23° C.) for Experimental rubber Sample B with the in-chain functionalized polybutadiene significantly increased to a value of 51.1 as compared to a value of 40.2 for its Control rubber Sample A with a non-functionalized lithium polybutadiene.

From Table 2 it can further be seen that the Grosch rate of abrasion for rubber Sample B which contained the in-chain functionalized polybutadiene decreased (improved) to a value of 145 mg/km as compared to a value of 154 mg/km for its Control rubber Sample A with a non-functionalized lithium polybutadiene.

From Table 2 it is seen that the tan delta value (−10° C.) for Experimental rubber Sample B with the in-chain functionalized polybutadiene significantly decreased to a value of 0.22 as compared to a value of 0.27 for its Control rubber Sample A with a non-functionalized lithium polybutadiene.

It is concluded that the presence of the in-chain functionalized polybutadiene enabled a more uniform dispersion of the precipitated silica throughout the rubber composition, instead of being primarily concentrated in the low bound styrene-containing terminal di-functionalized styrene/butadiene portion of the rubber composition which led to:

(1) beneficially improved (increased) rebound value (at 23° C.) which is indicative of beneficially decreased hysteresis with predictive reduced internal heat build-up of a tire component during service of the tire and predictive beneficial reduced rolling resistance for a tire having a component (e.g. tread) of such rubber composition;

(2) beneficially improved (reduced) Grosch abrasion rate which is predictive of increased resistance to treadwear for a tire having a tread of such rubber composition, and

(3) similar tan delta (−10° C.) values which is indicative that wet traction of a tire tread of such composition would be similar.

(B) For Immiscible Elastomer Blends as Control Rubber Sample C and Experimental Rubber Sample D reported in Table 2

Rubber Samples C and D both contained the terminal di-functional styrene/butadiene elastomer with 40 percent bound styrene.

Control rubber Sample C contained non functionalized lithium polybutadiene elastomer.

Experimental rubber Sample D contained in-chain functionalized lithium polybutadiene copolymer.

From Table 2 it is seen that the rebound value (23° C.) for Experimental rubber Sample D with the in-chain functionalized polybutadiene significantly increased to a value of 47.2 as compared to a value of 36.2 for its Control rubber Sample C with a non-functionalized lithium polybutadiene. From Table 2 it can further be seen that the Grosch rate of abrasion for rubber Sample

D which contained the in-chain functionalized polybutadiene significantly decreased (improved) to a value of 109 mg/km as compared to a value of 123 mg/km for its Control rubber Sample C with a non-functionalized lithium polybutadiene.

From Table 2 it is seen that the tan delta value (−10° C.) of 0.38 for Experimental rubber Sample D with the in-chain functionalized polybutadiene was about the same the tan delta value of 0.37 for its Control rubber Sample A with a non-functionalized lithium polybutadiene.

It is concluded that the presence of the in-chain functionalized polybutadiene enabled a more uniform dispersion of the precipitated silica throughout the rubber composition, instead of being primarily concentrated in the high bound styrene-containing terminal di-functionalized styrene/butadiene portion of the rubber composition which led to:

(A) significantly beneficially improved (increased) rebound value (at 23° C.) which is indicative of a significantly beneficially reduced hysteresis with predictive reduced internal heat build-up of a tire component during service of the tire and predictive beneficial reduced rolling resistance for a tire having a component (e.g. tread) of such rubber composition;

(B) significantly beneficially improved (reduced) Grosch abrasion rate which is predictive of a significantly increased resistance to treadwear for a tire having a tread of such rubber composition, and

(C) similar tan delta (-10° C.) values which is indicative that wet traction of a tire tread of such composition would be substantially maintained.

EXAMPLE II Vehicular tires were prepared of tire size P225/60R16 having treads comprised of rubber compositions represented by Samples A, B, C and D of Example I and tested for tire rolling resistance, treadwear and tread traction (stopping distance) with results reported in the following Table 3.

Tires A and B used treads comprised of a miscible blend of elastomers (Samples) A and B, respectively, which were comprised of a miscible blend of the terminal di-functionalized SBR containing about 23 percent bound styrene together with the in-chain functionalized polybutadiene for Experimental Tire B and non-functionalized polybutadiene for Control Tire A.

Tires C and D used treads comprised of immiscible blend of elastomers (Samples) C and D, respectively, which were comprised of an immiscible blend of the terminal di-functionalized SBR containing about 40 percent bound styrene and the in-chain functionalized polybutadiene for Experimental Tire D and the non-functionalized polybutadiene for Control Tire C.

TABLE 3

| | Tires | | | |
|---|---|---|---|---|
| | A | B | C | D |
| Functionalized SBR rubber A (23% styrene) | 70 | 70 | 0 | 0 |
| Functionalized SBR rubber B (40% styrene) | 0 | 0 | 70 | 70 |
| Polybutadiene rubber (lithium polybutadiene) | 30 | 0 | 30 | 0 |
| Functionalized polybutadiene rubber (lithium | 0 | 30 | 0 | 30 |
| polybutadiene copolymer) | | | | |
| Miscibility of elastomers | Yes | Yes | No | No |

The values below are normalized to a value of 100 for Control Tire A
(with Tread of Miscible Elastomer Blend) and for Control Tire C
(with Tread of Immiscible Elastomer Blend)

| | | | | |
|---|---|---|---|---|
| Tread Rolling Resistance - higher value is better | 100 | 109 | 100 | 114 |
| (representing lower rolling resistance) | | | | |
| Wet Stopping Distance (car test) - higher value is | 100 | 96 | 100 | 100 |
| better (representing shorter stopping distance) | | | | |
| Wet Traction (trailer test) - higher value is better | 100 | 97 | 100 | 102 |
| (representing greater traction) | | | | |
| Dry Traction (trailer test) - higher value is better | 100 | 99 | 100 | 103 |
| (representing greater traction) | | | | |
| Treadwear - higher value is better | 100 | 119 | 100 | 115 |
| (representing greater resistance to treadwear) | | | | |

It can be seen from Table 3 that both rolling resistance and tread wear values were significantly and beneficially improved with the addition of the in-chain functionalized polybutadiene to the terminal di-functionalized styrene/butadiene rubber of the silica reinforcement-containing rubber compositions for Tires (treads) B and D without significantly effecting their wet traction as compared to their individually associated comparative Control tires A and C, respectively which did not contain the ion-chain functionalized polybutadiene rubber.

For comparison of use of the immiscible blend and miscible blends of the functionalized polybutadiene and functionalized styrene/butadiene rubber in the silica reinforcement containing rubber composition for the tire tread, it is observed that:

(A) A significant advantage in performance is observed, particularly for tire Rolling Resistance and Treadwear resistance, for Tire D with its tread comprised of an immiscible blend of in-chain functionalized polybutadiene and terminal di-functionalized styrene/butadiene (B) containing 40 percent bound styrene.

(B) A beneficial increase, but somewhat less of a significant advantage, in tire performance, particularly for tire Rolling Resistance and Treadwear resistance, as observed for Tire B with its tread comprised of a miscible blend of the in-chain functionalized polybutadiene and terminal di-functionalized styrene/butadiene (A) containing 23 percent bound styrene.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic rubber tire having a component of a rubber composition comprised of, based upon parts by weight per 100 parts by weight of rubber (phr):
(A) from about 50 to about 80 phr of a solution polymerization prepared styrene/butadiene rubber (S-SBR) terminally di-functionalized at one terminal end of said styrene/butadiene rubber with a combination of both alkoxysilane and either amine or thiol groups wherein said (S-SBR) has a bound styrene content of:
(1) from about 15 to 34 percent bound styrene units, or
(2) from 35 to about 45 percent bound styrene units, and
(B) from about 5 to about 70 phr of in-chain functionalized polybutadiene elastomer with a having a cis 1,4-isomeric content in a range of from about 30 to about 50 percent, a trans 1,4-isomeric content in a range of from about 40 to about 60 percent which contains in-chain functionalization comprised of from about 0.2 to about 1.5 weight percent functional groups bound in the polybutadiene polymer chain;
wherein said in-chain functionalized polybutadiene elastomer is comprised of a copolymer of in-chain repeat units derived from:
(1) 1,3-butadiene monomer; and
(2) functionalized monomer in amount of from about 0.2 to about 1.5 weight percent of said 1,3-butadiene monomer having a structural formula comprised of Formula (I): 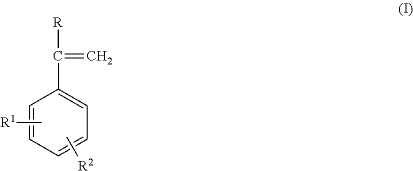
where R represents an alkyl group containing from 1 to 10 carbon atoms or a hydrogen atom and where R¹ and R² are the same or different and represent hydrogen atom, provided that both R¹ and R² cannot be hydrogen, or moiety comprised of Formula (II) or Formula (III): 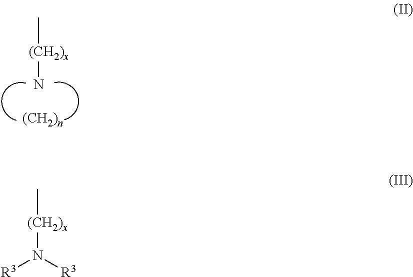
where R³ groups are the same or different and represent alkyl groups containing from 1 to 10 carbon atoms , aryl groups, allyl groups and alkyloxy groups comprised of the structural formula (IV):
—(CH₂)_{y}—O—(CH₂)_{z}—CH₂ (IV)
where n, x, y and z represent integers ranging from 1 to 10.

2. The tire of claim 1 wherein said rubber composition contains about 40 to about 135 phr of reinforcing filler comprised of:
(A) amorphous synthetic precipitated silica (precipitated silica), or
(B) rubber reinforcing carbon black, or
(C) combination of said precipitated silica and rubber reinforcing carbon black.

3. The tire of claim 2 wherein reinforcing filler is comprised of precipitated silica and rubber reinforcing carbon black of a weight ratio in a range of from about 1/1 to about 10/1.

4. The tire of claim 1 wherein said rubber composition contains a coupling agent for said precipitated silica having a moiety reactive with hydroxyl groups on said precipitated silica and another moiety interactive with one of said elastomers.

5. The tire of claim 1 wherein said functionalized monomer represented by structural formula (I) is pyrrolidine ethyl styrene.

6. The tire of claim 1 wherein said functional monomer represented by structural (I) is vinyl benzyl pyrrolidine.

7. The tire of claim 1 wherein said functionalized monomer represented by structural formula (I) is vinyl benzyl dimethyl amine.

8. The tire of claim 1 wherein said in-chain functionalized polybutadiene is comprised of repeat units derived from 1,3-butadiene and at least one of pyrrolidine ethyl styrene, vinyl benzyl dimethyl amine and vinyl benzyl pyrrolidine.

9. The tire of claim 1 wherein said in-chain functionalized polybutadiene copolymer further contains from about 2 to about 25 percent repeat units derived from isoprene.

10. The tire of claim 1 wherein said in-chain functionalized polybutadiene rubber is a copolymer of 1,3-butadiene and functionalized monomer prepared by anionic copolymerization of the 1,3-butadiene and functional monomers in a hydrocarbon solvent in the presence of a polymerization initiator comprised of n-butyllithium to initiate the copolymerization for which is added a polymerization modifier to promote incorporation of said functional monomer units along the polybutadiene chain comprised of tetramethylethylenediamine.

11. The tire of claim 1 wherein said terminal di-functionalized styrene/butadiene elastomer is styrene/butadiene elastomer containing terminal functionalization comprised of a combination of alkoxysilane and primary amino groups.

12. The tire of claim 1 wherein said terminal di-functionalized styrene/butadiene elastomer is styrene/butadiene elastomer containing terminal functionalization comprised of a combination of alkoxysilane and thiol groups.

13. The tire of claim 1 wherein said terminal di-functionalized styrene/butadiene elastomer is at least partially chain extended with tin tetrachloride or silicon tetrachloride.

14. The tire of claim 1 wherein said in-chain functionalized polybutadiene elastomer is at least partially chain extended with tin tetrachloride or silicon tetrachloride.

15. The tire of claim 1 wherein said terminal di-functionalized styrene/butadiene rubber is comprised of the Formula (V): 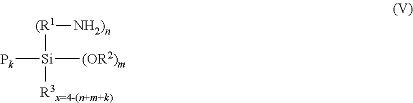
wherein P is a copolymer chain of styrene/butadiene copolymer, R¹ is an alkylene group having 1 to 12 carbon atoms, R² and R³ are each independently selected from an alkyl group having 1 to 20 carbon atoms, an allyl group or an aryl group, where R² is preferably an ethyl group, n is a value of 1 or 2, m is a value of from 1 or 2, preferably 2, k is a value of from 1 or 2, x is a value of 0 to 1, with the proviso that n+m+k is an integer of 3 or 4.

16. The tire of claim 1 wherein said terminal di-functionalized styrene/butadiene rubber terminally di-functionalized with an alkoxysilane group and a thiol as a reaction product of a living anionic styrene/butadiene polymer and a silane-sulfide represented by the formula VI:
(R⁴O)ₓR⁴_{y}Si—R⁵—S—SiR⁴₃ (VI)
wherein Si is silicon; S is sulfur; O is oxygen; x is an integer selected from 1, 2 and 3; y is an integer selected from 0, 1, and 2; x+y=3; R⁴ is the same or different and is (C₁-C₁₆)alkyl; and R′ is aryl, and alkyl aryl, or (C₁-C₁₆)alkyl. In one embodiment, R⁵ is a (C₁-C₁₆)alkyl. In one embodiment, each R⁴ group is the same or different, and each is independently a C₁-C₅ alkyl, and R⁵ is C₁-C₅ alkyl.

17. The tire of claim 1 wherein said terminal di-functional styrene/butadiene elastomer contains from about 18 to about 28 percent bound styrene units.

18. The tire of claim 1 wherein said terminal di-functional styrene/butadiene elastomer contains from about 35 to about 45 percent bound styrene units.

19. The tire of claim 1 wherein said rubber composition contains sulfur cure ingredients comprised of sulfur, primary sulfur cure accelerator comprised of N—N-dicyclohexyl-2-benzothiazolesulfenamide and secondary sulfur cure accelerator comprised of zinc dibenzyldithiocarbamate exclusive of diphenyl guanidine.

20. The tire of claim 1 wherein said rubber composition contains sulfur cure ingredients comprised of sulfur and sulfur cure accelerator(s) exclusive of diphenylguanidine.
